(19) United States
(12) Patent Application Publication
(10) Pub. No.: US 2002/0115455 A1
(43) Pub. Date: Aug. 22, 2002

(54) Extended range cordless telephone system and method

(75) Inventors: James S. Umstetter, Taylor, TX (US); Elie Jreij, Pflugerville, TX (US)

Correspondence Address: Siemens Corporation, Attn: Elsa Keller, Legal Administrator, Intellectual Property Department, 186 Wood Avenue South, Iselin, NJ, 08830, US

(73) Assignee: SIEMENS INFORMATION AND COMMUNICATION PRODUCTS, LLC

(21) Appl. No.: 09/791,181

(22) Filed: Feb. 22, 2001

(51) Int. Cl. H04B 7/15

(52) U.S. Cl. 455/462; 455/11.1; 455/517

(57) ABSTRACT

An extended range cordless telephone system in which a cordless handset may be configured to extend the operating range of a base station is described. The local cordless handset is operable selectively to exchange wireless voice signals with the base station and to relay wireless communication signals between the base station and a remote cordless handset in response to a received mode selection signal.

### TECHNICAL FIELD

This invention relates to systems and methods for extending the geographic coverage range of a cordless telephone system.

### BACKGROUND

Cordless telephone systems in the United States currently operate on separate radio frequency pairs (or channels) within relatively narrow frequency bands (e.g., 46-49 MHz, 902-928 MHz, and 2.4 GHz). A cordless telephone system typically includes a base station that is connected by a fixed wireline connection to a public switched telephone network (PSTN), and one or more cordless handsets that communicate with the base station over one of the available radio frequency channels. A user may make and receive telephone calls with a cordless handset anywhere within a limited distance (e.g., a few hundred feet) away from the base station. The actual range of operation depends upon a number of different factors, including the radiation power of the base station and the cordless handsets and the radio wave propagation characteristics of the geographic coverage area.

A number of different systems have been proposed for extending the geographic coverage range of a cordless telephone system. For example, U.S. Pat. No. 6,078,821 describes a cordless telephone system that includes a master base station, a slave base station, and a cordless handset. The master base station communicates with the slave base station to coordinate communications with the cordless handset. In particular, the master base station controls the slave base station so that the cordless handset may communicate with the master base station when the cordless handset is within the coverage area of the master base station and may communicate with the slave base station when the cordless handset is within the coverage area of the slave base station. As a result, the slave base station may be located some distance away from the master base station to extend the operating range of the cordless telephone system. The slave base station may be stationary or mobile so long as the slave base station is positioned within the geographic coverage area of the master base station. U.S. Pat. No. 5,321,736 describes another cordless telephone system in which one or more stationary RF repeaters are distributed over an area to extend the coverage range of a base station. The RF repeaters communicate with the base station over a coaxial cable connection. Still other extended range cordless telephone systems have been proposed.

### SUMMARY

The invention features an extended range cordless telephone system in which a cordless handset may be configured to extend the operating range of a base station.

In one aspect of the invention, the cordless telephone system comprises a local cordless handset that is operable to relay wireless communication signals between a base station and a remote cordless handset.

Embodiments of the invention may include one or more of the following features.

The local cordless handset preferably is operable to relay voice and control wireless communication signals between the base station and the remote cordless handset. The local cordless handset preferably is operable to transmit and receive control signals over an RF control channel and to transmit and receive voice signals over an RF voice channel. The local cordless handset preferably is configured to selectively generate an audible output or a wireless transmission from a received wireless communication signal.

The local cordless handset preferably is operable to exchange wireless voice signals with the base station. The local cordless handset preferably comprises an antenna, an RF receiver, an RF transmitter, a microphone, and a speaker. The local cordless handset may comprise a controller for directing a received wireless communication signal selectively to the speaker or to the RF transmitter. The controller may be configured to direct a received wireless communication signal selectively to the speaker or to the RF transmitter in response to a received mode selection signal. The mode selection signal may be received from a user of the local cordless handset or may be embedded in a received wireless communication signal.

The local cordless handset may comprise a mode selection switch that is operable to selectively configure the local cordless handset as a wireless repeater or a cordless handset.

The cordless telephone system may include an intermediate cordless handset that is operable to relay wireless communication signals between the local cordless handset and the remote cordless handset.

The cordless telephone system also may include a base station having a port configured to couple to a telephone wireline of a public switched telephone network. The base station may be configured to transmit to the local cordless handset a mode selection signal for selectively configuring the local cordless handset as a wireless communication device or a wireless repeater.

In another aspect, the invention features a cordless telephone method in accordance with which wireless voice signals are selectively exchanged with a base station and wireless communication signals are selectively relayed between the base station and a remote cordless handset in response to a received mode selection signal.

Among the advantages of the invention are the following.

The invention provides a flexible scheme for extending the geographic coverage area of a cordless telephone system. The inventive dual mode cordless handset may be placed at any location within the geographic coverage area of the base station to extend the geographic coverage area of the base station by encompassing an additional geographic coverage area surrounding the cordless handset. Thus, a user of the remote cordless handset may make and receive telephone calls anywhere within the resulting extended coverage area. In addition, a user conveniently may use the cordless handset to make and receive telephone calls anywhere within the original geographic coverage area of the base station.

Other features and advantages of the invention will become apparent from the following description, including the drawings and the claims.

### DESCRIPTION OF DRAWINGS

FIG. 1A is a diagrammatic view of a cordless handset exchanging wireless telephone communication signals with a base station.

FIG. 1B is a diagrammatic view of the cordless handset of FIG. 1A relaying wireless telephone communication signals between the base station and a remote cordless handset.

FIG. 2 is a block diagram of the cordless handset of FIG. 1A.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

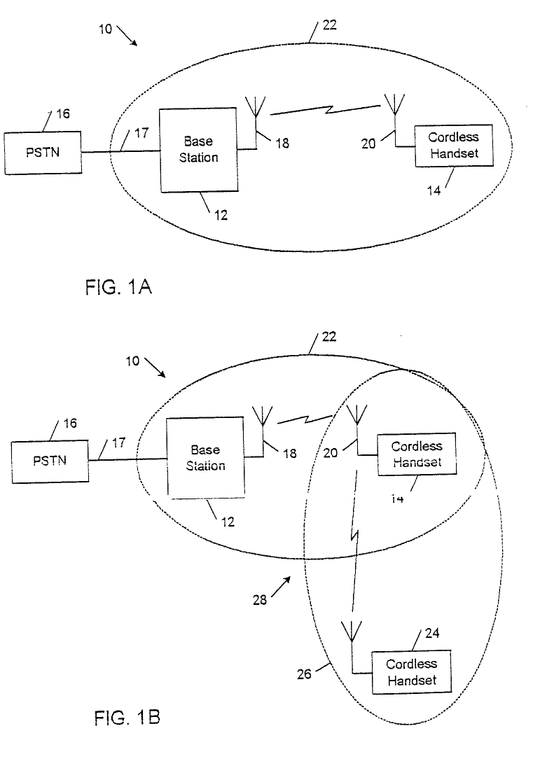

Referring to FIG. 1A, in one embodiment, a cordless telephone system 10 includes a base station 12 and a cordless handset 14. Base station 12 is connected to a public switched telephone network (PSTN) 16 by a fixed wireline connection 17. Base station 12 communicates with cordless handset 14 over one or more radio frequency (RF) communication channels. The RF communication channels may lie within the 46-49 MHz frequency band, the 902-928 MHz frequency band, or the 2.4 GHz frequency band. Base station 12 and cordless handset 14 include respective antennas 18, 20 for exchanging RF communication signals. Base station 12 communicates with cordless handset 14 over a control channel in order to designate one or more voice channels over which wireless communication signals may be exchanged between base station 12 and cordless handset 14. In operation, base station 12 modulates telephone communication signals received from PSTN 16 onto a radio carrier for transmission to cordless handset 14. Base station 12 also demodulates RF telephone communication signals received from cordless handset 14 into electrical signals for transmission to PSTN 16 over fixed wireline connection 17. A user of cordless handset 14 may make and receive telephone calls anywhere within a limited geographic coverage area 22 surrounding base station 12. The geographic coverage area 22 typically may extend only a few hundred feet away from base station 12.

Referring to FIG. 1B, in addition to exchanging wireless telephone communication signals with base station 12, cordless handset 14 may operate as an RF repeater between base station 12 and a remote cordless handset 24 that is located outside of geographic coverage area 22. In this mode of operation, cordless handset 14 merely receives and retransmits wireless communication signals received from base station 12 and remote cordless handset 24. Cordless handset 14 therefore may be used to extend the geographic coverage area of base station 12 to include an additional geographic coverage area 26 surrounding cordless handset 14. As a result, a user of remote cordless handset 24 may make and receive telephone calls anywhere within an extended coverage area 28 that encompasses both geographic coverage area 22 and geographic coverage area 26.

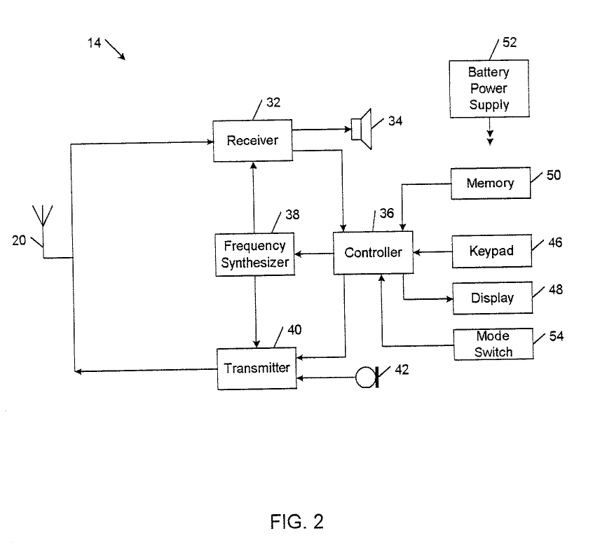

Referring to FIG. 2, cordless handset 14 includes a receiver 32, a speaker 34, a controller 36, a frequency synthesizer 38, a transmitter 40, a microphone 42, a keypad 46, a display 48, a memory 50, and a battery power supply 52. Cordless handset 14 also includes a mode selection switch 54 that enables a user to selectively configure cordless handset 14 as a wireless communication device or an RF repeater. Controller 36 choreographs the operation of receiver 32, transmitter 40 and frequency synthesizer 38. Frequency synthesizer 38 controls the operating frequencies of receiver 32 and transmitter 40, and generates electronic ring signals in response to control signals received from controller 36.

In a wireless communication device mode of operation, cordless handset 14 operates as a conventional cordless telephone handset. Thus, telephone calls may be placed and received through cordless handset 14, which communicates with base station 12 over one or more of the available voice channels. Base station 12 operates to exchange voice signals between PSTN 16 and cordless handset 14. In particular, when a call initially is received from PSTN 16, base station 12 transmits a ring signal to cordless handset 14 over an RF control channel. In response, speaker 34 generates an audible ring signal from an electronic ring signal received from frequency synthesizer 38. After the user takes cordless handset 14 off hook, base station 12 transmits a voice signal from PSTN 16 to cordless handset 14 over an available voice channel. Antenna 20 converts the RF communication signals received from base station 12 into electrical signals. Receiver 32 filters and demodulates the electrical signals to produce electrical voice signals. Speaker 34 generates from the electrical voice signals an audible voice message for the user of cordless handset 14. Microphone 42 converts responsive audible voice messages received from the user of cordless handset 14 into an electrical voice signals. Transmitter 40 modulates the electrical voice signals onto a radio carrier supplied by frequency synthesizer 38. Antenna 20 transmits the modulated radio carrier with the responsive voice message to base station 12.

In an RF repeater mode of operation, cordless handset 14 operates as an RF repeater that is configured to relay voice signals between base station 12 and remote cordless handset 24. Thus, telephone calls may be placed and received through remote cordless handset 24 anywhere within the extended geographic coverage area 28. Base station 12 and cordless handset 14 both operate together to exchange voice signals between PSTN 16 and remote cordless handset 24. In particular, when a call initially is received from PSTN 16, base station 12 transmits a ring signal to cordless handset 14 over an RF control channel. In response, cordless handset 14 relays the ring signal to remote cordless handset 24 over the RF control channel. After the user takes remote cordless handset 24 off hook, base station 12 transmits a voice signal from PSTN 16 to cordless handset 14. In response, cordless handset 14 relays the voice signal to remote cordless handset 24 over an RF voice channel. Similarly, cordless handset 14 relays responsive voice signals received from remote cordless handset 24 over the RF voice channel to base station 12, which demodulates the responsive voice signals and transmits the demodulated voice signals to PSTN 16. In operation, antenna 20 converts RF communication signals received from base station 12 and remote cordless handset 24 into electrical signals. Receiver 32 filters and demodulates the electrical signals to produce electrical voice signals. Controller 36 directs the electrical voice signals to transmitter 40, which modulates the electrical voice signals onto a radio carrier supplied by frequency synthesizer 38. Antenna 20 transmits the modulated radio carrier to remote cordless handset 24 and base station 12. In this mode of operation, controller 36 isolates speaker 34 and microphone 42 from receiver 32 and transmitter 40, respectively.

Wireless communication signals may be transmitted between base station 12 and cordless handset 14 and between cordless handset 14 and remote cordless handset 24 in accordance with conventional channel selection, signal coding and other cordless telephone transmission protocols.

Remote cordless handset 24 may be a conventional cordless handset or it may be operable to selectively switch between a cordless handset mode of operation and an RF repeater mode of operation. In the latter case, remote cordless handset 24 may be located some distance away from cordless handset 14 within geographic coverage area 26 to further extend the geographic coverage range of base station 12 with respect to an additional cordless handset.

Other embodiments are within the scope of the claims. For example, cordless handset 14 may be configured to switch automatically between a cordless handset mode of operation and a repeater mode of operation in response to a mode selection control signal received from base station 12 or remote cordless handset 24, or both. Cordless handset 14 also may automatically switch from a repeater mode of operation to a cordless handset mode of operation in response to a user's selection of a “talk” control button on keypad 46.

Still other embodiments are within the scope of the claims.

What is claimed is:

1. A cordless telephone system, comprising a local cordless handset operable to relay wireless communication signals between a base station and a remote cordless handset.

2. The system of claim 1, wherein the local cordless handset is operable to relay voice and control wireless communication signals between the base station and the remote cordless handset.

3. The system of claim 2, wherein the local cordless handset is operable to transmit and receive control signals over an RF control channel.

4. The system of claim 2, wherein the local cordless handset is operable to transmit and receive voice signals over an RF voice channel.

5. The system of claim 1, further comprising an intermediate cordless handset operable to relay wireless communication signals between the local cordless handset and the remote cordless handset.

6. The system of claim 1, wherein the local cordless handset is operable to exchange wireless voice signals with the base station.

7. The system of claim 1, wherein the local cordless handset comprises an antenna, an RF receiver, an RF transmitter, a microphone, and a speaker.

8. The system of claim 7, wherein the local cordless handset further comprises a controller for directing a received wireless communication signal selectively to the speaker or to the RF transmitter.

9. The system of claim 8, wherein the controller is configured to direct a received wireless communication signal selectively to the speaker or to the RF transmitter in response to a received mode selection signal.

10. The system of claim 9, wherein the mode selection signal is received from a user of the local cordless handset.

11. The system of claim 8, wherein the mode selection signal is embedded in a received wireless communication signal.

12. The system of claim 1, wherein the local cordless handset comprises a mode selection switch operable to selectively configure the local cordless handset as a wireless repeater or a cordless handset.

13. The system of claim 1, wherein the local cordless handset is configured to selectively generate an audible output or a wireless transmission from a received wireless communication signal.

14. The system of claim 1, further comprising a base station having a port configured to couple to a telephone wireline of a public switched telephone network.

15. The system of claim 14, wherein the base station is configured to transmit to the local cordless handset a mode selection signal for selectively configuring the local cordless handset as a wireless communication device or a wireless repeater.

16. A cordless telephone system, comprising:
a base station;
a remote cordless handset; and
a local cordless handset operable selectively to exchange wireless voice signals with the base station and to relay wireless communication signals between the base station and the remote cordless handset in response to a received mode selection signal.

17. The system of claim 16, wherein the local cordless handset is configured to selectively generate an audible output or a wireless transmission from a received wireless communication signal.

18. The system of claim 16, wherein the mode selection signal is received from a user of the local cordless handset.

19. The system of claim 16, wherein the mode selection signal is embedded in a received wireless communication signal.

20. A cordless telephone method, comprising selectively exchanging wireless voice signals with a base station and relaying wireless communication signals between the base station and a remote cordless handset in response to a received mode selection signal.
